(19) United States
(12) Patent Application Publication
(10) Pub. No.: US 2026/0316833 A1
(43) Pub. Date: Oct. 15, 2026

(54) VEHICLE CONTROL DEVICE, VEHICLE CONTROL METHOD, AND PROGRAM

(71) Applicant: HONDA MOTOR CO., LTD., Tokyo (JP)

(72) Inventors: Yasuyuki Ishida, Tokyo (JP); Yuki Imanishi, Tokyo (JP)

(21) Appl. No.: 19/466,573

(22) Filed: Feb. 2, 2026

(30) Foreign Application Priority Data
Feb. 25, 2025 (JP) 2025-027741

(51) Int. Cl. B62D 15/02

(52) U.S. Cl. CPC B62D 15/0255

(57) ABSTRACT

A vehicle control device includes a recognition part configured to recognize a surrounding situation of a vehicle and a control part configured to generate a target trajectory of the vehicle for each specified time based on a recognition result of the recognition part and perform at least steering control of the vehicle based on the generated target trajectory. The control part generates the next target trajectory so that a deviation amount between a previous target trajectory and the next target trajectory is less than or equal to a specified amount when the deviation amount exceeds the specified amount.

### CROSS-REFERENCE TO RELATED APPLICATION

Priority is claimed on Japanese Patent Application No. 2025-027741, filed Feb. 25, 2025, the content of which is incorporated herein by reference.

### BACKGROUND OF THE INVENTION

### Field of the Invention

The present invention relates to a vehicle control device, a vehicle control method, and a program.

### Description of Related Art

Recently, efforts to provide access to sustainable transportation systems have been increasingly active in consideration of vulnerable individuals among participants in transportation. For this realization, research and development efforts are focused on further improving the safety and convenience of transportation through research and development related to driving assistance technology.

In this regard, conventionally, technology for increasing a steering reaction force received by a driver of a vehicle from a steering wheel when the driver steers the steering wheel excessively is known (see, for example, Patent Document 1 (Japanese Unexamined Patent Application, First Publication No. H4-362475)).

### SUMMARY OF THE INVENTION

Meanwhile, driving assistance technology has a problem because a steering reaction force is applied in a direction opposite to an intended direction during steering control for the vehicle and appropriate steering control cannot be performed.

In order to solve the above problem, an objective of the present application is to provide a vehicle control device, a vehicle control method, and a program that enable more appropriate steering control to be performed in accordance with a situation of a vehicle. The present invention contributes to the development of sustainable transportation systems.

A vehicle control device, a vehicle control method, and a program according to the present invention adopt the following configurations.

(1): According to an aspect of the present invention, there is provided a vehicle control device including: a recognition part configured to recognize a surrounding situation of a vehicle; and a control part configured to generate a target trajectory of the vehicle for each specified time based on a recognition result of the recognition part and perform at least steering control of the vehicle based on the generated target trajectory, wherein the control part generates a next target trajectory so that a deviation amount between a previous target trajectory and the next target trajectory is less than or equal to a specified amount when the deviation amount exceeds the specified amount. (2): In the above-described aspect (1), the next target trajectory may be a target trajectory generated to suppress steering overshoot caused by the steering control.

(3): In the above-described aspect (1), the steering control may be steering control during a lane change of the vehicle.

(4): In the above-described aspect (3), when control of the vehicle is switched from lane keeping control to lane change control and a lateral deviation amount of a target trajectory immediately before or after the switching is greater than or equal to a threshold, the control part may generate the next target trajectory so that the deviation amount is less than or equal to a specified amount during the lane change of the vehicle.

(5): In the above-described aspect (1), the control part may generate the target trajectory based on a mode selected from among a plurality of modes for generating a predetermined target trajectory, based on information including the deviation amount.

(6): According to another aspect of the present invention, there is provided a vehicle control method including: recognizing, by a computer, a surrounding situation of a vehicle; generating, by the computer, a target trajectory of the vehicle for each specified time based on a recognition result; performing, by the computer, at least steering control of the vehicle based on the generated target trajectory, and generating, by the computer, a next target trajectory so that a deviation amount between a previous target trajectory and the next target trajectory is less than or equal to a specified amount when the deviation amount exceeds the specified amount.

(7): According to yet another aspect of the present invention, there is provided a program for causing a computer to: recognize a surrounding situation of a vehicle; generate a target trajectory of the vehicle for each specified time based on a recognition result; perform at least steering control of the vehicle based on the generated target trajectory, and generate a next target trajectory so that a deviation amount between a previous target trajectory and the next target trajectory is less than or equal to a specified amount when the deviation amount exceeds the specified amount.

According to the above-described aspects (1) to (7), it is possible to perform more appropriate steering control in accordance with a situation of a vehicle.

### BRIEF DESCRIPTION OF THE DRAWINGS

FIG. 1 is a configuration diagram of a vehicle on which a vehicle control device of an embodiment is mounted.

FIG. 2 is an explanatory diagram of an example of a function of a mode selection part 142A.

FIG. 3 is a diagram showing an example of a scene in which a target trajectory is generated.

FIG. 4 is an explanatory diagram of a target trajectory generation process in an overshoot suppression mode.

FIG. 5 is a flowchart showing an example of a process executed by a driving assistance device 100 according to an embodiment.

FIG. 6 is a flowchart showing an example of the target trajectory generation process.

### DETAILED DESCRIPTION OF THE INVENTION

Hereinafter, embodiments of a vehicle control device, a vehicle control method, and a program of the present invention will be described with reference to the drawings.

### Overall Configuration

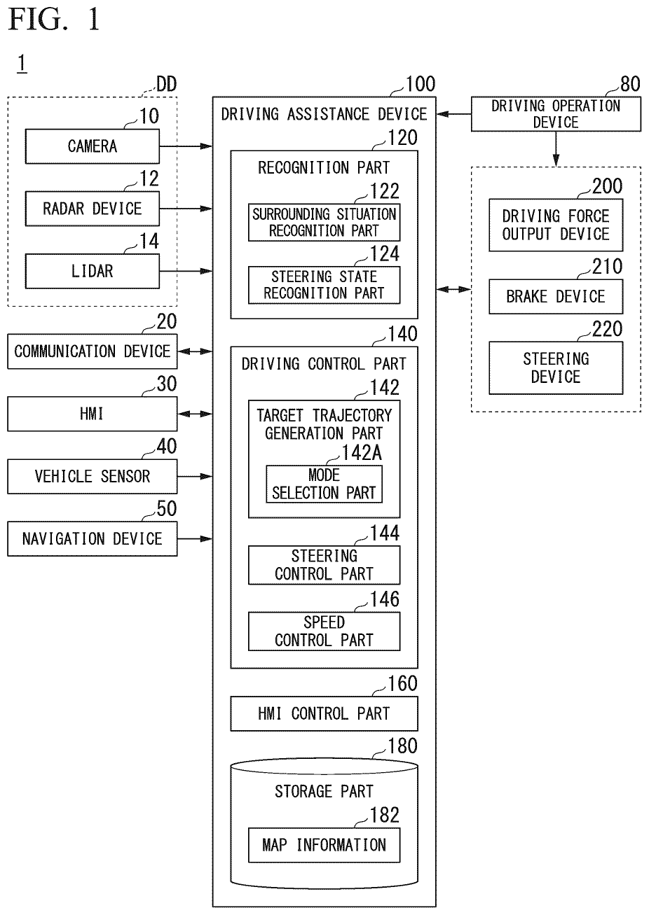

FIG. 1 is a configuration diagram of a vehicle on which a vehicle control device of the present embodiment is mounted. A vehicle (hereinafter referred to as a vehicle M) on which the vehicle control device is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery or a fuel cell is discharged.

For example, the vehicle M includes a camera 10, a radar device 12, a light detection and ranging (LIDAR) 14, a communication device 20, a human machine interface (HMI) 30, a vehicle sensor 40, a navigation device 50, a driving operation device 80, a driving assistance device 100, a driving force output device 200, a brake device 210, and a steering device 220. Such devices and equipment are connected to each other by a multiplex communication line such as a controller area network (CAN) communication line, a serial communication line, a wireless communication network, or the like. In addition, the configuration shown in FIG. 1 is merely an example and some of the constituent elements may be omitted or other constituent elements may be further added. A combination of the camera 10, the radar device 12, and the LIDAR 14 is an example of a “detection device DD.” The driving assistance device 100 is an example of a “vehicle control device.”

For example, the camera 10 is a digital camera using a solid-state imaging element such as a charge-coupled device (CCD) or a complementary metal oxide semiconductor (CMOS). The camera 10 is attached to any location on the vehicle M on which the vehicle system 1 is mounted. For example, when the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the sides of the vehicle M are imaged, the camera 10 is attached to left and right door mirrors or the like. For example, the camera 10 periodically and iteratively images the surroundings of the vehicle M. The camera 10 may be a stereo camera.

The radar device 12 radiates radio waves (radar) such as millimeter waves around the vehicle M and detects at least a position of a physical object (a distance from the physical object and a direction of the physical object) by detecting radio waves (reflected waves) reflected by the physical object near the vehicle M. The radar device 12 is attached to any location on the vehicle M. The radar device 12 may detect a position and a speed of the physical object in a frequency-modulated continuous wave (FM-CW) scheme.

The LIDAR 14 radiates light to the vicinity of the vehicle M and measures scattered light. The LIDAR 14 detects a distance from an object based on time from light emission to light reception. The radiated light is, for example, pulsed laser light. The LIDAR 14 is attached to any location on the vehicle M.

The communication device 20, for example, communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the vehicle M and receives input operations from the occupants. The HMI 30 includes, for example, a display part and a speaker. The display part is, for example, a liquid crystal display (LCD), an organic electro-luminescence (EL) display device, or the like. The display part displays various types of images (including videos) in the embodiment. The display part may be configured to be integrated with an input as a touch panel. The speaker outputs a specified sound (e.g., an alert sound, a message sound, or the like). Moreover, the HMI 30 may include microphones, buzzers, touch panels, switches, keys, and the like. The switches may include a switch for executing or ending specified driving control executable by a traveling control part to be described below, a switch for approving (permitting) or rejecting a driving control recommendation (proposal) from a system (vehicle system 1) side, and the like. Moreover, the switches may include a switch (turn signal switch) for performing a direction indication operation and the like.

The vehicle sensor 40 includes a vehicle speed sensor configured to detect the speed of the vehicle M, an acceleration sensor configured to detect acceleration, and a yaw rate sensor configured to detect a yaw rate (e.g., a rotational angular velocity around a vertical axis passing through the center of gravity of the vehicle M). Moreover, the vehicle sensor 40 may include a lateral acceleration sensor (lateral G sensor) that detects the lateral acceleration (lateral G) of the vehicle M, a steering angle sensor that detects a steering angle of the vehicle M (which may be an angle of the steering wheel or an operation angle of the steering wheel), a steering angular velocity sensor that detects a steering angular velocity, a direction sensor that detects a direction of the vehicle M, and the like.

Moreover, the vehicle sensor 40 may include a position sensor configured to detect the position of the vehicle M. The position sensor is, for example, a sensor configured to acquire position information (longitude/latitude information) from a Global Positioning System (GPS) device. Moreover, for example, the position sensor may be a sensor configured to acquire position information using a global navigation satellite system (GNSS) receiver of the navigation device 50. The vehicle sensor 40 may derive the speed of the vehicle M from a position information difference (i.e., a distance) at a specified time in the position sensor. A detection result of the vehicle sensor 40 is output to the driving assistance device 100.

For example, the navigation device 50 includes the GNSS receiver, a navigation HMI, and a route decision part. The navigation device 50 may store map information in a storage device such as a hard disk drive (HDD) or a flash memory or may acquire map information 182 stored in the storage part 180 to be described below. The GNSS receiver identifies a position of the vehicle M based on a signal received from a GNSS satellite. The position of the vehicle M may be identified or complemented by an inertial navigation system (INS) using an output of the vehicle sensor 40. The navigation HMI includes a display device, a speaker, a touch panel, a key, and the like. The GNSS receiver may be provided in the vehicle sensor 40. The navigation HMI may be partly or wholly shared with the above-described HMI 30. For example, the route decision part decides a route (hereinafter referred to as a route on a map) from the position of the vehicle M identified by the GNSS receiver (or any input position) to a destination input by the occupant using, for example, the navigation HMI with reference to the map information 182 or the like. Moreover, the navigation device 50 provides route guidance using the navigation HMI based on the decided route on the map. The navigation device 50 may transmit a current position and a destination to a navigation server via the communication device 20 and acquire a route equivalent to the route on the map from the navigation server.

Here, the map information 182 is, for example, information in which a road shape is expressed by a link indicating a road (an example of a movement route) and nodes connected by the link. The map information 182 may include point of interest (POI) information, and the like. Moreover, the map information 182 includes, for example, the number of lanes (the number of movement routes), a type and shape of a road marking, information about a center of a lane or information about a road boundary, and the like. The map information 182 may include information about whether or not the road boundary is a boundary (physical boundary) including a structure through which the vehicle cannot pass (including crossing or contacting). Physical boundaries are, for example, guardrails, curbs, medians, fences, and the like. Moreover, the map information 182 may include road shape information, traffic regulation information, address information (address and postal code), facility information, parking lot information, phone number information, and the like. The road shape information is, for example, information such as the curvature of the road (which may also be expressed as a radius of curvature, and the same applies hereinafter), a width, a road surface gradient (including vertical and horizontal (transverse) gradients (banks)), and information about branching points, merging points, intersections, T-junctions, and the like. The map information 182 may be updated at any time when the communication device 20 communicates with an external device.

The driving operation device 80 includes, for example, a steering wheel, an accelerator pedal, and a brake pedal. Moreover, the driving operation device 80 may include a shift lever, a variant steering wheel, a joystick, and other operation devices. For example, an operation detection part configured to detect an amount of operation on the operation device by the driver or the presence or absence of operation is attached to each operation device in the driving operation device 80. The operation detection part detects, for example, a steering angle and steering torque of the steering wheel (e.g., an amount of steering based on a driving operation of the driver (steering input torque)), a steering torque variation rate, an amount of depression of the accelerator pedal or the brake pedal, and the like. Also, the operation detection part outputs the detection result to the driving assistance device 100, or to one or all of the driving force output device 200, the brake device 210, and the steering device 220. Moreover, the driving operation device 80 may include a direction indication operation part (e.g., a turn signal lever or a turn signal switch). When the direction indication operation part has been operated, a turn signal (direction indicator) of the vehicle M associated with the operation content blinks, and the operation content (e.g., including a result of detecting an operation performed by the driver) is output to the driving assistance device 100.

The driving assistance device 100 executes various types of control for assisting the driver of the vehicle M in driving. The driving assistance device 100 includes, for example, a recognition part 120, a driving control part 140, an HMI control part 160, and a storage part 180. Each of the recognition part 120, the driving control part 140, and the HMI control part 160 is implemented, for example, by a hardware processor such as a central processing unit (CPU) executing a program (software). Moreover, some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as an HDD or a flash memory of the driving assistance device 100 or may be stored in a removable storage medium such as a digital versatile disc (DVD), a compact disc-read-only memory (CD-ROM), or a memory card and installed in the storage device of the driving assistance device 100 when the storage medium (the non-transitory storage medium) is mounted on a drive device, a card slot, or the like. The driving control part 140 is an example of a “control part.” The HMI control part 160 is an example of a “notification control part.”

The storage part 180 may be implemented by the above-described various storage devices, an electrically erasable programmable read-only memory (EEPROM), a read-only memory (ROM), a random-access memory (RAM), or the like. The storage part 180 stores, for example, the map information 182, various types of information in embodiments, programs, and the like. Moreover, the storage part 180 may store various types of setting information for use in the process in the present embodiment.

The recognition part 120, for example, includes a surrounding situation recognition part 122 and a steering state recognition part 124. The surrounding situation recognition part 122 recognizes a surrounding situation of the vehicle M, for example, based on a detection result of the detection device DD (information input from the camera 10, the radar device 12, and the LIDAR 14). For example, the surrounding situation recognition part 122 performs a sensor fusion process on some or all of the detection results of the camera 10, the radar device 12, and the LIDAR 14 to recognize states such as the position (the relative position from the vehicle M), size, speed (a relative speed from the vehicle M), and acceleration of a physical object located in the vicinity of the vehicle M (within a specified distance). Physical objects recognized by the surrounding situation recognition part 122 may include, for example, traffic participants (examples of obstacles) such as other vehicles, pedestrians, bicycles, and the like in addition to physical boundaries that divide the road (movement route). The position of the physical object, for example, is recognized as a position on absolute coordinates with a representative point (the center of gravity, the center of a drive shaft, or the like) of the vehicle M as the origin, and is used for control. The position of the physical object may be indicated by a representative point such as the center of gravity or a corner of the physical object or may be indicated by an area that has been represented. The “state” of the physical object may include, for example, the acceleration or jerk of another vehicle, or the “action state” (e.g., whether or not the other vehicle is changing lanes or is about to change lanes) when the physical object is the other vehicle.

Moreover, the surrounding situation recognition part 122 may recognize, for example, a stop line, a red light, a toll booth, other road events, road signs, and markings drawn on the road (e.g., speed limits), and the like. Moreover, the surrounding situation recognition part 122 may recognize the curvature of a travel lane (travel road) of the vehicle M based on the detection results of the detection device DD or the map information 182.

Moreover, the surrounding situation recognition part 122 recognizes, for example, a lane in which the vehicle M is traveling (a travel lane), other lanes located in a nearby area (e.g., adjacent lanes), and the like. For example, the surrounding situation recognition part 122 recognizes a road marking from an image captured by the camera 10, and recognizes the travel lane and other lanes based on a positional relationship of the recognized road markings seen from the vehicle M. Moreover, the surrounding situation recognition part 122 may recognize the lane in which the vehicle M is traveling or other lanes with reference to the map information 182 based on the position information of the vehicle M obtained from the vehicle sensor 40 and the like.

The steering state recognition part 124 recognizes a steering state of the vehicle M based on a detection result of the vehicle sensor 40 and a detection result of the operation detection part of the driving operation device 80. For example, the steering state recognition part 124 recognizes a steering amount from the steering angle of the vehicle M detected by the steering angle sensor. Moreover, the steering state recognition part 124 may recognize the steering amount (a steering angle, steering torque, or the like) resulting from the driver's operation on the steering wheel from the operation detection part of the driving operation device 80.

The driving control part 140 executes driving control of the vehicle M in accordance with the recognition result of the recognition part 120, the detection result of the vehicle sensor 40, instruction content received by the HMI 30, operation content received by the driving operation device 80, and the like. The driving control is, for example, a control process for driving the vehicle M by controlling at least one of the steering and speed of the vehicle M, regardless of the driver's driving operation, or by receiving only some of the operation instructions. Moreover, the driving control may include driving assistance control such as an advanced driver assistance system (ADAS) that assists the driver of vehicle M in driving. The driving control may include, for example, adaptive cruise control system (ACC) control (tracking control), lane keeping assistance system (LKAS) control (lane keeping control), auto lane changing (ALC) control, auto lane changing assist (ALCA) control, collision mitigation braking system (CMBS) control, and the like. The ALC control is, for example, control (lane change control) for executing a lane change based on a surrounding situation without receiving an operational instruction from the driver (regardless of the presence or absence of an operation), while the ALCA control is control (lane change control) for executing a lane change based on a surrounding situation after receiving an operation instruction from the driver (e.g., a change lane instruction from a direction indicator operation part).

The driving control part 140 includes a target trajectory generation part 142, a steering control part 144, and a speed control part 146. The target trajectory generation part 142 sets a target trajectory from a current position of the vehicle M so that the vehicle M travels along a route to arrive at a destination set in, for example, the navigation device 50 or the like. The target trajectory includes information (e.g., a time-series trajectory point) regarding a position (trajectory point) at each specified time (first specified time) in the future. Moreover, the target trajectory may include information about a speed element of the vehicle M. Moreover, the target trajectory generation part 142 sets a target trajectory for the vehicle M to execute specified driving control (e.g., ALC control or LKAS control) or the like of an instruction from the driver through the HMI 30 or the like. The target trajectory generation part 142 iteratively generates a target trajectory for each specified time (second specified time) in accordance with a position, direction, surrounding situation, or the like of the vehicle M.

Moreover, the target trajectory generation part 142 includes, for example, a mode selection part 142A. When the target trajectory is generated, the mode selection part 142A selects one of a plurality of predetermined modes in accordance with the situation of the vehicle M. The target trajectory generation part 142 generates a target trajectory in accordance with the mode selected by the mode selection part 142A. A function of the mode selection part 142A will be described in detail below.

The steering control part 144 performs steering control of the vehicle M so that the vehicle M travels along the target trajectory set by the target trajectory generation part 142. For example, the steering control part 144 performs steering control so that the vehicle M travels along a target trajectory for traveling in the center of the travel lane based on the surrounding situation recognized by the surrounding situation recognition part 122 when LKAS control is being executed. Moreover, when ALC control or ALCA control is being executed, the steering control part 144 performs steering control for moving the vehicle M to an adjacent lane that is a lane change destination along the target trajectory for the lane change.

For example, the steering control part 144 decides a steering amount according to proportional-integral-differential (PID) control based on the position of the vehicle M, the target trajectory, and the like, and executes steering control for the decided steering amount. Moreover, the steering control part 144 may perform steering control (steering reaction force control) for applying a reaction force to the steering wheel or the like to suppress disturbance in the behavior of the vehicle M (excessive steering) based on the steering amount recognized by the steering state recognition part 124. Moreover, the steering control part 144 may perform steering control for avoiding contact between the obstacle and the vehicle M, for example, when the distance between the obstacle and the vehicle M is within a specified distance.

The speed control part 146 controls the speed of the vehicle M so that the vehicle M travels along the target trajectory set in the target trajectory generation part 142. For example, in driving control such as ACC for tracking a preceding vehicle, the speed control part 146 controls the speed of the vehicle M in accordance with the speed of the preceding vehicle so that a distance from the preceding vehicle continues to be within a specified distance. Moreover, when the distance between an obstacle and the vehicle M is within the specified distance, the speed control part 146 may execute speed control such as sudden deceleration to avoid contact between the obstacle and the vehicle M. A steering control process of the steering control part 144 and a speed control process of the speed control part 146 may be executed in parallel.

The HMI control part 160 notifies occupants (including the driver) of specified information through the HMI 30 and receives information input by the HMI 30. The specified information includes, for example, information about the traveling of the vehicle M, such as information about the state of the vehicle M and information about driving control. The information about the state of the vehicle M includes, for example, a speed of the vehicle M, an engine speed, a shift position, and the like. Moreover, the information about the driving control includes, for example, information about whether or not the driving control is being performed by the driving control part 140, information about an execution situation of the driving control, information about driving control recommendations (proposals) from the system side, and notification information (alerts and the like) for the occupant. Moreover, the specified information may include information about the surrounding situation recognized by the detection device DD. Moreover, the specified information may include information unrelated to the driving of the vehicle M, such as a television program and content (e.g., a video) stored in a storage medium such as a DVD. Moreover, the specified information may include, for example, information about the current position and destination of the vehicle M, and the remaining amount of fuel in the vehicle M.

The HMI control part 160 may output information received by the HMI 30 to the communication device 20, the navigation device 50, the recognition part 120, the driving control part 140, and the like. For example, when the HMI 30 receives an instruction to execute specified driving control, the HMI control part 160 outputs content of the driving control of the instruction to the driving control part 140.

Moreover, the HMI control part 160 may generate inquiry information or recommendation information for the occupant, a recognition result of the recognition part 120, control content of the driving control part 140, notification information, and the like, and output the generated information to the HMI 30. The generated information includes images and sounds (including notification sounds and the like). Moreover, the HMI control part 160 may transmit various types of information to be output by the HMI 30 via the communication device 20 to terminal devices used by the occupants of the vehicle M.

Moreover, the HMI control part 160 may generate map information about the surroundings of the vehicle M extracted from the map information 182 based on the vehicle M's position information, information indicating the surrounding situation recognized by the surrounding situation recognition part 122, information indicating the target trajectory set by the target trajectory generation part 142, and the like and cause the HMI 30 to display the information.

The driving force output device 200 outputs a driving force (torque) for enabling the vehicle M to travel to driving wheels. For example, the driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving control part 140 or information input from the accelerator pedal of the driving operation device 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving control part 140 or the information input from the brake pedal of the driving operation device 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the driving control part 140 and transfer the hydraulic pressure of the master cylinder to the cylinder.

For example, the steering device 220 includes a steering ECU and an electric motor. For example, the electric motor changes directions of steerable wheels by applying a force to a rack and pinion mechanism. The steering ECU drives the electric motor in accordance with the information input from the driving control part 140 or the information input from the steering wheel of the driving operation device 80 to change the directions of the steerable wheels.

### Mode Selection

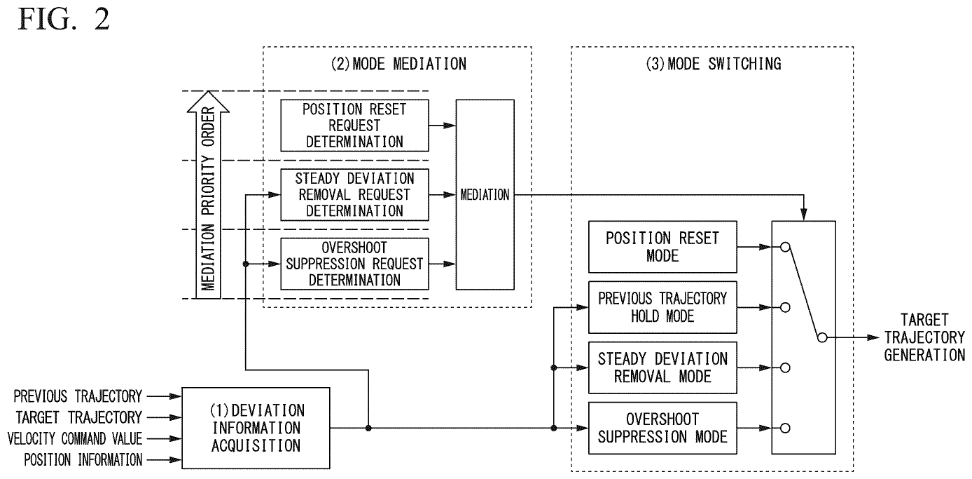

Next, a function of the mode selection part 142A will be described in detail. FIG. 2 is an explanatory diagram of an example of the function of the mode selection part 142A. As shown in FIG. 2, the mode selection part 142A performs processes including a deviation information acquisition process ((1) in the drawing), a mode mediation process ((2) in the drawing), and a mode switching process ((3) in the drawing). Each process will be described below.

### (1) Deviation Information Acquisition Process

In the deviation information acquisition process, the mode selection part 142A, for example, inputs a previous trajectory (a current target trajectory), a target trajectory (the next provisional target trajectory to be used as a reference), a velocity command value, and position information of the vehicle M and performs time-series trajectory conversion between the previous trajectory and the target trajectory to acquire a lateral deviation amount (first lateral deviation amount) between the previous trajectory and the target trajectory. Moreover, the mode selection part 142A may acquire a lateral deviation amount (second lateral deviation amount) between the previous trajectory and the position information of the vehicle M. The first lateral deviation amount and the second lateral deviation amount are examples of the deviation information. Moreover, the deviation amount may be referred to as a variation amount, a movement amount, or a change amount.

### (2) Mode Mediation Process

Next, based on the deviation information acquired during the deviation information acquisition process, the vehicle position, the surrounding situation, and the like in the mode mediation process, the mode selection part 142A, for example, determines whether or not to make a position reset request for resetting the position of the vehicle M regardless of the past position information, whether or not to make a steady deviation removal request for removing a steady deviation caused by an error in the detection device DD such as the camera 10 (e.g., an error in which a lane always appears tilted due to a lateral gradient (bank)), or whether or not to make an overshoot suppression request for suppressing overshoot (the vehicle M being steered beyond the target trajectory) caused by an increase in an amount of steering due to an excessive increase in the lateral deviation amount (e.g., the second lateral deviation amount). For example, the mode selection part 142A determines to make the position reset request when the vehicle M has departed from its lane and is unable to keep in its lane. Moreover, the mode selection part 142A determines to make the steady deviation removal request when there is a lateral gradient greater than or equal to a threshold in the current travel lane of the vehicle M based on the map information 182 and the like or when the deviation amount corresponds to the steady deviation amount. Moreover, the mode selection part 142A determines to make the overshoot suppression request when the second lateral deviation amount is greater than or equal to a specified value. In addition, the types of requests are not limited to the above example.

Moreover, when it is determined that a plurality of requests need to be made, the mode selection part 142A performs the mediation process to determine which mode corresponding to which of the requests is to be executed. In this case, the mode selection part 142A performs the mediation process so that the highest-ranked mode is executed based on a preset priority level. In the example of FIG. 2, the overshoot suppression request, the steady deviation removal request, and the position reset request are listed in descending order of priority, but the order is not limited thereto.

### (3) Mode Switching Process

Next, the mode selection part 142A switches the mode based on the request output from the mode mediation. In the example shown in FIG. 2, the types of modes include a position reset mode, a previous trajectory hold mode, a steady deviation removal mode, and an overshoot removal mode, but the types of modes are not limited thereto. The position reset mode is, for example, a mode for generating a new target trajectory based on current position information of the vehicle M. The previous trajectory hold mode is, for example, a mode for holding (continuing) the previous target trajectory as it is because the vehicle M is currently traveling normally along the target trajectory (because the lateral deviation between the vehicle M and the target trajectory is less than a threshold). The steady deviation removal mode is, for example, a mode for generating a target trajectory for removing a preset steady deviation amount. The overshoot suppression mode is, for example, a mode for generating a target trajectory that limits a steering amount to prevent overshoot from occurring. One of these modes is selected by mode switching, and a target trajectory is generated according to the selected mode.

### Target Trajectory Generation and Steering Control

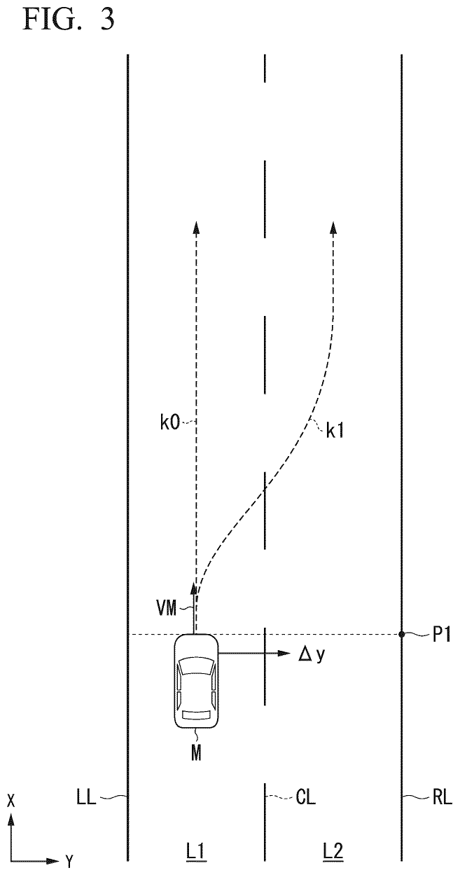

Next, specific examples of target trajectory generation and steering control will be described. Hereinafter, the target trajectory generation and the steering control will be mainly described in the overshoot suppression mode. FIG. 3 is a diagram showing an example of a scene in which a target trajectory is generated. In the example of FIG. 3, the vehicle M traveling at a speed VM in a lane L1 between two lanes L1 and L2 where traveling is possible in the same direction (the X-axis direction in the drawing) is shown. The lane L1 is defined by road markings LL and CL and the lane L2 is defined by road markings CL and RL. Moreover, the road marking CL is a marking that allows the lane change. For example, it is assumed that the driving control part 140 generates a target trajectory k0 for the vehicle M to travel along the center of the lane L1 and executes driving control (e.g., LKAS control) for allowing the vehicle M to travel along the generated target trajectory k0.

In this situation, at a timing when the vehicle M has reached a point P1, when the driver (an example of an occupant) of the vehicle M operates a direction indicator (e.g., a turn signal lever) to make the lane change from the lane L1 that is a travel lane to the lane L2 that is an adjacent lane, the driving control part 140 switches the driving control from the LKAS control to the ALCA control. Moreover, the driving control part 140 (more specifically, the target trajectory generation part 142) generates a target trajectory k1 for the vehicle M to travel from its current position to the center of the lane L2 based on the position information of the vehicle M and the surrounding situation. Also, the driving control part 140 executes at least steering control of steering and speed for traveling along the generated target trajectory k1.

Here, in the steering control according to the present embodiment, a steering amount (steering force) SP for traveling along the target trajectory k1 is decided by proportional-integral-differential (PID) control as shown in the following formula (1).

SP=(Kp•Δy)+(Ki•∫Δydt)+(kd•Δy/dt) . . . (1)

In formula (1), Δy denotes a second lateral deviation amount (e.g., an amount of movement between the vehicle M's position and the target trajectory k1 in a road width direction (the Y-axis direction in the drawing)), Kp denotes a gain of the proportional term (P term), Ki denotes a gain of the integral term (I term), and Kd denotes a gain of the differential term (D term). In other words, in the PID control, control is performed according to an input value of each of the P term of the numerical value of the target route, the I term of the integral value, and the D term of the differential value.

For example, as shown in FIG. 2, because instantaneous displacement increases from the target trajectory k0 to the target trajectory k1 according to switching from the LKAS control (lane keeping control) to the ALCA control (lane change control), a first lateral deviation amount between the target trajectories k0 and k1 increases and a second lateral deviation amount Δy between the vehicle M and the target trajectory k1 also increases. Moreover, as the lateral deviation amount increases, the differential value of the PID control increases and the D term also increases. Therefore, the steering amount SP also increases, and overshoot is more likely to occur if the steering amount SP increases to a specified amount or more.

Therefore, in the case as described above (e.g., when the first lateral deviation amount or the second lateral deviation amount Δy of the target trajectory before or after the switching is greater than or equal to a threshold), the mode selection part 142A selects the overshoot suppression mode and the target trajectory generation part 142 generates a target trajectory for suppressing overshoot.

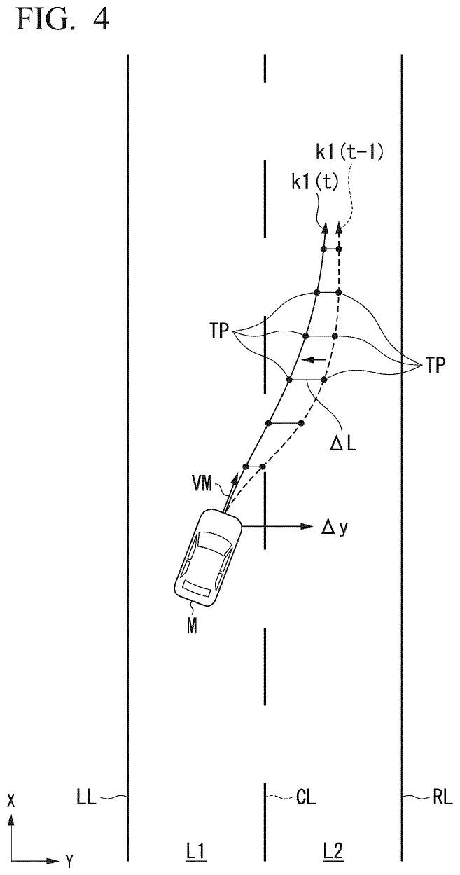

FIG. 4 is an explanatory diagram of a target trajectory generation process in overshoot suppression mode. In the example of FIG. 4, a current target trajectory (a previous trajectory that the vehicle M currently uses as a reference) k1(t−1) for making the lane change to the lane L2, and the next target trajectory (a target trajectory that the vehicle M plans to use as the next reference) k1(t) are shown. Moreover, in FIG. 4, TP denotes a trajectory point. The trajectory point TP on the target trajectory k1(t−1) or k1(t) is a time-series trajectory point. In the case of the overshoot suppression mode, the target trajectory generation part 142, for example, generates a target trajectory k1(t) shifted toward the lane L1 side (the vehicle M side) so that the second lateral deviation amount Δy decreases (or so that it is less than a threshold at which no overshoot is predicted to occur).

Here, if a target trajectory in which the second lateral deviation amount Δy is smaller is generated (in other words, if a target trajectory in which the first lateral deviation amount ΔL between the target trajectory k1(t−1) and the target trajectory k1(t) is larger is generated), steering control that more reliably suppresses overshoot becomes possible. However, for example, as shown in FIG. 4, in a state in which the vehicle M is under steering control along the target trajectory k1(t−1), when the target trajectory is switched to the next target trajectory k1(t), because the target trajectory is shifted toward the lane L1 side, the steering (steering reaction force control) is exerted in a direction opposite to a direction in which the lane L2 to which the driver intends to make the lane change is located (a direction intended by the driver). Moreover, in this situation, the differential value in the PID control becomes a large numerical value, and the D term becomes dominant.

Therefore, the target trajectory generation part 142 generates the next target trajectory k1(t) by limiting the first lateral deviation amount ΔL for the target trajectory k1(t−1) to a specified amount or less. In this case, the target trajectory generation part 142 acquires a first lateral deviation amount ΔL for each trajectory point TP between the target trajectory k1(t−1) and the target trajectory k1(t). When there is any part where a deviation amount exceeds the specified amount among a plurality of first lateral deviation amounts ΔL that have been acquired, the target trajectory generation part 142 sets the first lateral deviation amounts ΔL for that part to a value of the specified amount. In addition, the target trajectory generation part 142 applies a deviation amount for any part where the deviation amount is less than or equal to the specified amount among the plurality of first lateral deviation amounts ΔL as it is. Thereby, the final target trajectory k1(t) is generated. The specified amount may be a fixed amount (e.g., 0.02 [m]) or a variable value according to the type, speed, and road shape of the vehicle M.

In this target trajectory generation process, for example, a target trajectory is iteratively generated every specified time (second specified time), in accordance with a position and orientation of the vehicle M, a surrounding situation, or the like. In this way, because the D term of the PID control can be reduced so that it does not become dominant in the PID control by limiting the deviation amount (a movement amount or a change amount) from the previous trajectory, control of the P and I terms can be more effective and steering control can continue in a right direction (lane change destination). Thereby, because overshoot is suppressed and steering reaction force control is also suppressed in a direction opposite to the driver's desired lane change direction, it is possible to perform more appropriate steering control in accordance with the situation of the vehicle.

In addition, when a mode other than the overshoot suppression mode is selected by the mode selection part 142A, a target trajectory according to the selected mode is generated (the previous trajectory is continuously used in the previous trajectory hold mode), and at least one of steering control and speed control is executed along the generated target trajectory.

### Modified Examples

The above-described target trajectory generation process of the target trajectory generation part 142 is not limited to the lane change, and, for example, may be executed during traveling on merging or branching roads, during traveling on curved roads, during traveling under steering control for avoiding contact with an obstacle, or the like.

The above-described target trajectory generation process of the target trajectory generation part 142 is not limited to a case where driving control is being performed and may also be applied to a case where a lane change or the like is made in a state in which the driver performs at least manual driving related to steering using the driving operation device 80 such as the steering wheel. In this case, the HMI control part 160 may cause a display part or the like of the HMI 30 to display the target trajectory generated by the target trajectory generation part 142 and prompt the driver to travel along the displayed target trajectory. Moreover, the steering control part 144 may perform steering reaction force control for suppressing excessive steering when excessive steering beyond the target trajectory is performed according to manual driving.

### Processing Flow

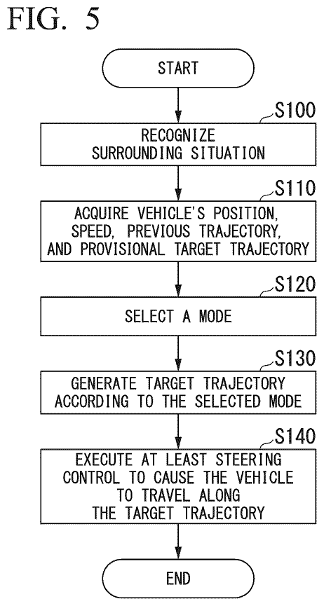

FIG. 5 is a flowchart showing an example of a process executed by the driving assistance device 100 in the present embodiment. In the example in FIG. 5, a process related to steering control among the processes executed by the driving assistance device 100 will be mainly described. It is assumed that, before the process shown in FIG. 5 is executed, the vehicle M is already traveling along a target trajectory generated based on specified driving control. Moreover, the process shown in FIG. 5 may be iteratively executed at specified timings.

In the example of FIG. 5, the recognition part 120 recognizes a surrounding situation of the vehicle M and the like (step S100). Subsequently, the mode selection part 142A acquires information such as the vehicle M's position, speed (velocity command value), previous trajectory, and next target trajectory (provisional target trajectory) (step S110) and selects one of a plurality of modes for generating a preset target trajectory based on the acquired information (step S120). Subsequently, the target trajectory generation part 142 generates (decides) a target trajectory according to the selected mode (step S130). Subsequently, the driving control part 140 (the steering control part 144 and the speed control part 146) performs at least steering control to cause the vehicle M to travel along the generated (decided) target trajectory (step S140). In the processing of step S140, speed control may be executed in addition to (or instead of) steering. Thereby, the process of the present flowchart ends.

### Step S130: Target Trajectory Generation

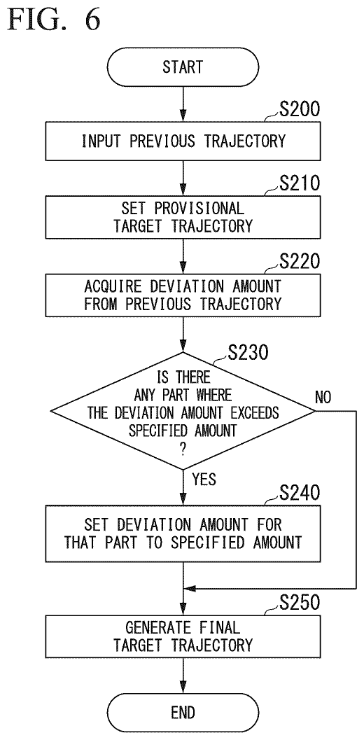

Next, a specific example of the target trajectory generation process shown in the above-described step S130 will be described using a flowchart. FIG. 6 is a flowchart showing an example of the target trajectory generation process. In addition, in the process of FIG. 6, the target trajectory generation process of a case where the overshoot suppression mode is set is shown as an example. In the example of FIG. 6, the target trajectory generation part 142 inputs a previous trajectory (step S200) and then sets the next target trajectory (provisional target trajectory) based on the previous trajectory and the position of the vehicle M and the like (step S210). The provisional target trajectory is, for example, a target trajectory that is shifted laterally relative to the previous trajectory to suppress the overshoot of the steering amount.

Subsequently, the target trajectory generation part 142 compares time-series trajectory points of the provisional target trajectory and the previous trajectory to acquire a deviation amount (lateral deviation amount) of the provisional target trajectory from the previous trajectory (step S220), and determines whether or not there is any part (trajectory point) where a deviation amount exceeds a specified amount among the plurality of trajectory points (step S230). When it is determined that there is any part where a deviation amount exceeds the specified amount, the target trajectory generation part 142 sets the deviation amount for that part (trajectory point) to a value of the specified amount (step S240). After the processing of step S240 or in the processing of step S230, when it is determined that there is no part where the deviation amount exceeds the specified amount, a final target trajectory is generated (decided) based on the deviation amount of each trajectory point (step S250). Thereby, the process of the present flowchart ends. By executing the process shown in FIG. 6, the next target trajectory where the deviation amount between the trajectory points is less than or equal to the specified amount is generated. Thereby, it is possible to suppress the occurrence of a steering reaction force in a direction opposite to a desired steering direction of the driver by suddenly shifting a target route so that it is closer to the vehicle M and it is also possible to suppress overshoot.

As described above, according to the embodiment, the vehicle control device includes the recognition part 120 configured to recognize a surrounding situation of the vehicle M; and the driving control part 140 (an example of a control part) configured to generate a target trajectory of the vehicle for each specified time based on a recognition result of the recognition part 120 and perform at least steering control of the vehicle M based on the generated target trajectory, wherein the driving control part 140 generates the next target trajectory so that a deviation amount between a previous target trajectory and the next target trajectory is less than or equal to a specified amount when the deviation amount exceeds the specified amount, whereby more appropriate steering control can be performed in accordance with a situation of the vehicle.

Specifically, in the embodiment, for example, when the target trajectory is switched from a target trajectory for straight travel or the like to a target trajectory for a lane change and when the target route is closer to the vehicle M side to suppress the overshoot of steering, the next target trajectory is iteratively generated so that an amount of deviation from the previous trajectory is less than or equal to a specified amount. Thereby, because the target route gradually moves closer to the vehicle side, a process for generating a steering reaction force in a direction opposite to a desired steering direction of the driver can be suppressed as the target route does not suddenly approach the vehicle M, and overshoot can be further suppressed. Moreover, according to the present embodiment, because the execution of steering unintended by the driver can be suppressed in the driving control executed at the vehicle system side, it is possible to reduce a possibility that a discomfort sense will be given to the driver.

The embodiment described above can be represented as follows.

A vehicle control device including:
a storage medium storing computer-readable instructions; and
a processor connected to the storage medium, the processor executing the computer-readable instructions to:
recognize a surrounding situation of a vehicle;
generate a target trajectory of the vehicle for each specified time based on a recognition result;
perform at least steering control of the vehicle based on the generated target trajectory, and
generate the next target trajectory so that a deviation amount between a previous target trajectory and the next target trajectory is less than or equal to a specified amount when the deviation amount exceeds the specified amount.

Although modes for carrying out the present invention have been described using embodiments, the present invention is not limited to the embodiments and various modifications and substitutions can also be made without departing from the scope and spirit of the present invention.

### EXPLANATION OF REFERENCES

10 Camera
12 Radar device
14 LIDAR
20 Communication device
30 HMI
40 Vehicle sensor
50 Navigation device
80 Driving operation device
100 Driving assistance device
120 Recognition part
122 Surrounding situation recognition part
124 Steering state recognition part
140 Driving control part
142 Target trajectory generation part
142A Mode selection part
144 Steering control part
146 Speed control part
160 HMI control part
180 Storage part
M Vehicle

What is claimed is:

1. A vehicle control device comprising:
a recognition part configured to recognize a surrounding situation of a vehicle; and
a control part configured to generate a target trajectory of the vehicle for each specified time based on a recognition result of the recognition part and perform at least steering control of the vehicle based on the generated target trajectory,
wherein the control part generates a next target trajectory so that a deviation amount between a previous target trajectory and the next target trajectory is less than or equal to a specified amount when the deviation amount exceeds the specified amount.

2. The vehicle control device according to claim 1, wherein the next target trajectory is a target trajectory generated to suppress steering overshoot caused by the steering control.

3. The vehicle control device according to claim 1, wherein the steering control is steering control during a lane change of the vehicle.

4. The vehicle control device according to claim 3, wherein, when control of the vehicle is switched from lane keeping control to lane change control and a lateral deviation amount of a target trajectory immediately before or after the switching is greater than or equal to a threshold, the control part generates the next target trajectory so that the deviation amount is less than or equal to a specified amount during the lane change of the vehicle.

5. The vehicle control device according to claim 1, wherein the control part generates the target trajectory based on a mode selected from among a plurality of modes for generating a predetermined target trajectory, based on information including the deviation amount.

6. A vehicle control method comprising:
recognizing, by a computer, a surrounding situation of a vehicle;
generating, by the computer, a target trajectory of the vehicle for each specified time based on a recognition result;
performing, by the computer, at least steering control of the vehicle based on the generated target trajectory, and
generating, by the computer, a next target trajectory so that a deviation amount between a previous target trajectory and the next target trajectory is less than or equal to a specified amount when the deviation amount exceeds the specified amount.

7. A program for causing a computer to:
recognize a surrounding situation of a vehicle;
generate a target trajectory of the vehicle for each specified time based on a recognition result;
perform at least steering control of the vehicle based on the generated target trajectory, and
generate a next target trajectory so that a deviation amount between a previous target trajectory and the next target trajectory is less than or equal to a specified amount when the deviation amount exceeds the specified amount.
